(19) United States
(12) Patent Application Publication
(10) Pub. No.: US 2026/0084442 A1
(43) Pub. Date: Mar. 26, 2026

(54) LIQUID EJECTION APPARATUS AND END PORTION DETECTION METHOD

(71) Applicant: CANON KABUSHIKI KAISHA, Tokyo (JP)

(72) Inventors: Yuto Nitami, Kanagawa (JP); Naoaki Wada, Kanagawa (JP); Akira Fujikake, Kanagawa (JP)

(21) Appl. No.: 19/332,241

(22) Filed: Sep. 18, 2025

(30) Foreign Application Priority Data
Sep. 20, 2024 (JP) 2024-164359

(51) Int. Cl. B41J 11/00; B41J 25/00; G01N 21/55

(52) U.S. Cl. CPC B41J 11/008; B41J 11/0095; B41J 25/005; G01N 21/55

(57) ABSTRACT

Provides a technique for a serial type liquid ejection apparatus to detect an end portion of printing paper with high accuracy. To this end, a carriage is moved at a constant speed until abutting an abutting portion while detecting an end portion of a printing medium by a sensor with high accuracy.

### BACKGROUND

### Field of the Technology

The present disclosure relates to a serial type liquid ejection apparatus and an end portion detection method.

### Description of the Related Art

A serial type liquid ejection apparatus is demanded to precisely detect a printing paper width and a printing paper end portion.

Japanese Patent Laid-Open No. 2017-065131 discloses a technique of detecting an edge of a printed image and an end portion of printing paper by a reflection type optical sensor provided to a carriage and, based on a detection result thereof, changing a print scanning start position during a printing operation.

Along with a size reduction of the apparatus in recent years, a movement range of the carriage becomes close to a width region of the printing paper. Under the circumstances, the carriage needs to decelerate before reaching a movement limiting position.

However, in a case where the carriage decelerates well before reaching the movement limiting position, the end portion of the printing paper is detected during the deceleration of the carriage. In this case, hunting occurs in the detection result, and it is difficult to detect a precise end portion position.

### SUMMARY

Therefore, the present disclosure provides a technique for a serial type liquid ejection apparatus to detect an end portion of printing paper with high accuracy.

Therefore, a liquid ejection apparatus of the present disclosure includes: a conveyance unit that conveys a sheet in a conveyance direction; a carriage in which a liquid ejection head is loaded and that can reciprocally move in a scanning direction crossing the conveyance direction; a first abutting portion that can be put in contact with the carriage in a movement limiting position of the carriage on one end side in the scanning direction; a second abutting portion that can be put in contact with the carriage in a movement limiting position of the carriage on a other end side opposing the one end side in the scanning direction; a first detection unit that is provided to an end portion of the carriage on the other end side and detects an end portion position of a printing medium while moving with the carriage; and a control unit that controls movement of the carriage and the first detection unit, in which, in a case where the first detection unit detects an end portion position of the printing medium on the one end side, the control unit moves the carriage at a constant speed until the carriage abuts the first abutting portion.

Features of the present disclosure will become apparent from the following description of embodiments with reference to the attached drawings. The following description of embodiments are described by way of example.

### BRIEF DESCRIPTION OF THE DRAWINGS

FIG. 1 is an exterior perspective view illustrating a liquid ejection apparatus.

FIG. 2 is a schematic view illustrating an internal mechanism of the liquid ejection apparatus.

FIG. 3 is a diagram illustrating a carriage put in contact with an abutting portion.

FIG. 4 is a block diagram illustrating a control unit in the liquid ejection apparatus.

FIG. 5 is a graph illustrating a movement speed of the carriage in a general liquid ejection apparatus.

FIG. 6 is a graph illustrating a change in the movement speed of the carriage.

FIG. 7 is a diagram illustrating a modification.

FIG. 8A is a diagram illustrating the carriage.

FIG. 8B is a graph illustrating a detection result.

FIG. 9 is a diagram illustrating a positional relationship between the carriage and a detection unit.

FIG. 10 is a diagram illustrating a positional relationship between the carriage and the detection unit.

FIG. 11 is a diagram showing the relationship between FIGS. 11A and 11B.

FIGS. 11A and 11B are flowcharts illustrating printing processing.

FIG. 12 is a diagram illustrating the carriage and a low accuracy sensor.

FIG. 13 is a diagram showing the relationship between FIGS. 13A and 13B.

FIGS. 13A and 13B are flowcharts illustrating printing processing.

### DESCRIPTION OF THE EMBODIMENTS

### First Embodiment

A first embodiment of the present disclosure is described below with reference to the drawings.

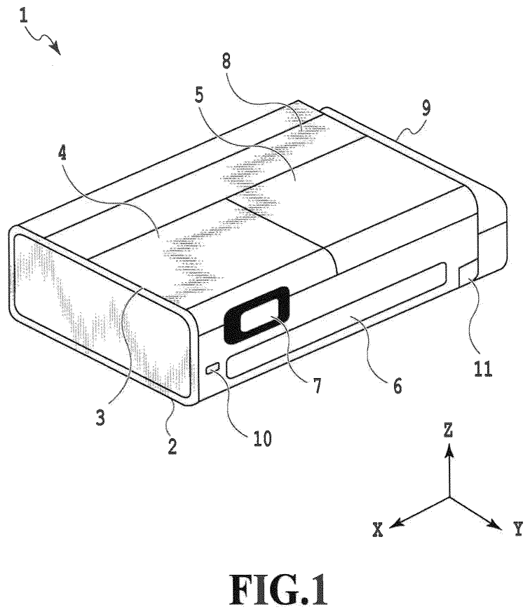

FIG. 1 is an exterior perspective view illustrating a liquid ejection apparatus 1 according to the present embodiment. The liquid ejection apparatus 1 is an ink jet printing apparatus that performs printing on a printing medium by ejecting an ink that is a liquid; however, the present disclosure is also applicable to various liquid ejection apparatuses other than the ink jet printing apparatus. Hereinafter, an X direction indicates a carriage scanning direction, a Y direction indicates a (substantial) conveyance direction, and a Z direction indicates a vertically upward direction.

Note that, “printing” includes not only a case of forming significant information such as a character and a graphic but also includes a case of forming an image, a design, a pattern, and the like or a case of processing a medium regardless of whether it is significant or insignificant, widely, and it is regardless of whether the information is visible to be visually sensed by a human. Additionally, although paper in the form of a sheet is assumed as the “printing medium” in the present embodiment, cloth, a plastic film, and the like may be applied.

The liquid ejection apparatus 1 has an exterior having a flat cuboid shape as a whole and includes an apparatus main body 2 and a main body cover portion 3 formed of multiple covers. The main body cover portion 3 is provided to cover the apparatus main body 2 and forms a top portion of the liquid ejection apparatus 1. The main body cover portion 3 includes a feeding cover 8 to set the printing medium, an access cover 5 for a maintenance work inside the apparatus, and a tank access cover 9 covering a portion to supply a tank of the apparatus with the ink. Additionally, the main body cover portion 3 is provided with a reading unit (a scanner unit) 4 that reads an image on a document, and the whole reading unit 4 can move to open and close similarly to the access cover 5 to allow for the maintenance work inside the apparatus.

In the liquid ejection apparatus 1, a discharge unit 6 that discharges the printing medium on which the printing is performed is formed. In addition, the liquid ejection apparatus 1 is provided with an operation unit 7 that accepts an operation by an operator. The operation unit 7 includes a display unit in the form of a touch panel to accept an input operation of the operator and display the information to the operator. Additionally, the liquid ejection apparatus 1 includes a notification unit 10 and can make a notification with a sound about an operation on each unit. Moreover, the liquid ejection apparatus 1 includes a waste liquid tank unit 11 to insert a waste liquid tank.

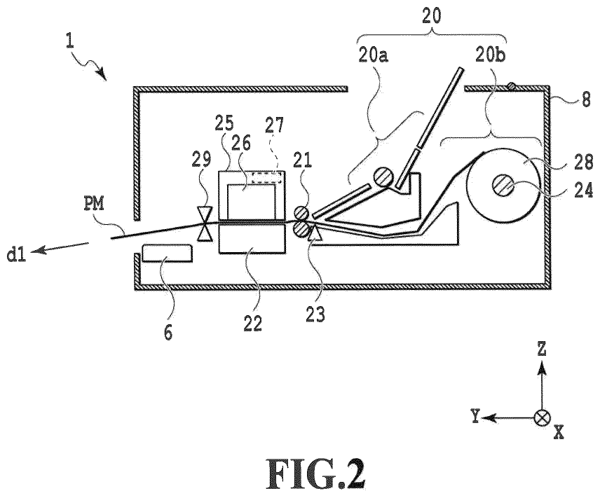

FIG. 2 is a schematic view illustrating an internal mechanism of the liquid ejection apparatus 1. The liquid ejection apparatus 1 includes a conveyance unit 21, a conveyance sensor 23, a feeding unit 20, a printing unit 26, and a cutter unit 29 and prints the image on a printing medium PM. The printing medium PM is stored in the feeding unit 20. The feeding unit 20 is formed to be able to store each of a cut sheet, which has a size conforming to predetermined standards, and a roll sheet, which is a long sheet wound in a roll shape, as a target to be selected as the printing medium PM (hereinafter, referred to as a printing target).

In the present embodiment, the feeding unit 20 includes a cut sheet stacking unit 20a formed to be able to stack multiple cut sheets and a roll sheet loading unit 20b in which the roll sheet is rotatably loaded in a position different from that of the cut sheet stacking unit 20a. Additionally, the cut sheet stacking unit 20a is arranged on a downstream side of the roll sheet loading unit 20b in a conveyance direction dl. Note that, an example of the above-described predetermined standards includes Japanese Industrial Standards (JlS). A printing operation on the roll sheet supplied from the roll sheet loading unit 20b is described below.

The roll sheet loading unit 20b includes a not-illustrated holding unit that holds the roll sheet, which is a continuous sheet wound in a roll shape, and a not illustrated driving unit that rotationally drives the sheet held by the holding unit. The roll sheet loading unit 20b supplies the roll sheet in a paper feeding direction of a roll sheet 28 (the Y direction indicated by an arrow) and a rewinding direction of the roll sheet 28 (a −Y direction) by rotating the roll sheet 28 held by the holding unit. A spool member 24 is inserted in a paper tube of the roll sheet 28 and pivotally supported by the holding unit of the feeding unit 20. The feeding unit 20 rotates the roll sheet 28 by rotating the spool member 24 by a motor (not illustrated).

The conveyance unit 21 is a conveyance roller to convey the printing medium PM. In a case of the present embodiment, the conveyance unit 21 includes a pair of a driving roller and a driven roller. The conveyance unit 21 includes a not illustrated driving mechanism and rotationally drives the driving roller. The driven roller is driven and rotated by being put in contact with pressure onto the driving roller. Accordingly, the printing medium PM is pinched by the driving roller and the driven roller and conveyed over a platen 22. For example, a gear mechanism including a motor as a driving source is adoptable to the driving mechanism of the conveyance unit 21. A rotation amount of the conveyance unit 21 is detected by a not-illustrated sensor (for example, an encoder), and a conveyance amount of the printing medium PM is controlled.

In the description hereinafter, in a case of mentioning _an upstream side and a downstream side, the direction of conveying the printing medium PM by the conveyance unit 21 is used as a reference. The conveyance direction of the printing medium PM is the Y direction, which is also called a sub scanning direction in some cases. The X direction indicates a direction crossing the conveyance direction of the printing medium PM, which is also called a main scanning direction or a paper width direction in some cases. The roll sheet 28 and the conveyance unit 21 are arranged such that axial directions thereof are parallel to the main scanning direction (the X direction).

The conveyance sensor 23 is arranged on the upstream side of the conveyance unit 21 in the conveyance direction, which is a sensor such as an optical sensor to determine whether the roll sheet 28 is properly conveyed to the conveyance unit 21.

The printing unit 26 is arranged on the downstream side of the conveyance unit 21 and formed to be able to print the image on the printing medium PM conveyed by the conveyance unit 21. In a case of the present embodiment, the printing unit 26 includes a printing head (a liquid ejection head) including multiple ejection ports that eject the ink.

The printing unit 26 can be loaded in a carriage 25, and an ink supply tube to supply the printing unit 26 with the ink is mounted in the carriage 25. Additionally, a detection unit 27 that detects an end edge and the like of the printing medium PM is attached to the carriage 25. The carriage 25 is formed to be able to reciprocally move in the X direction by a not-illustrated driving mechanism. As the driving mechanism of the carriage 25, for example, a belt driving mechanism including a motor as a driving source is adoptable. A position of the carriage 25 is detected by the not-illustrated detection unit 27 or a not-illustrated sensor (for example, an encoder), and movement of the carriage 25 is controlled.

The cutter unit 29 includes a cutter and cuts the printing medium PM in the X direction. The cutter unit 29 can reciprocally move in the X direction by a not illustrated cutter motor. Additionally, in an example, the cutter unit 29 may include a pressure sensor that detects a pressure related to the cutter.

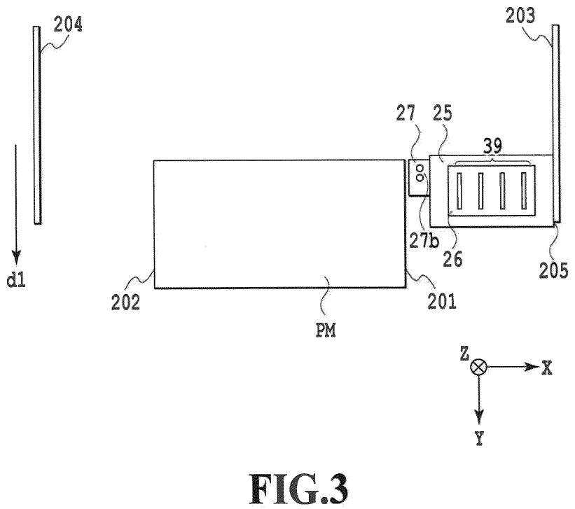

FIG. 3 is a diagram illustrating a situation of abutting portions 203 and 204 and the carriage 25 put in contact with the abutting portion 203 in the present embodiment. The carriage 25 includes the detection unit 27, and the printing unit 26 loaded in the carriage 25 includes a nozzle 39 that ejects the ink. The detection unit 27 includes a sensor 27b with high accuracy and is provided to a side surface of the carriage 25 on a non-reference side (a −X direction side in FIG. 3). The detection unit 27 can detect an end portion position of the printing medium PM by passing above two end portions of the printing medium PM in a +Z direction.

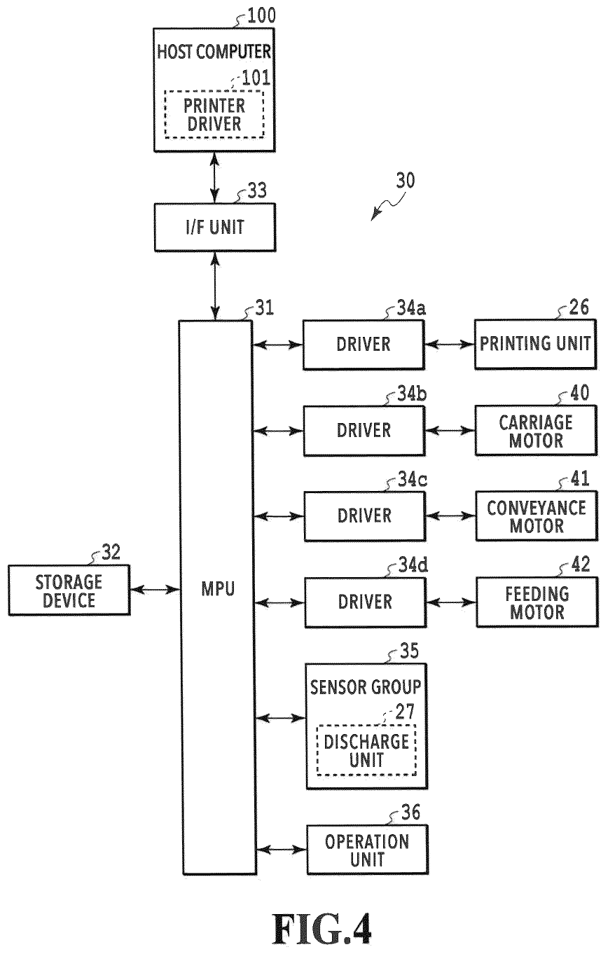

In the present specification, hereinafter, a target object to be described is described assuming that an abutting portion 203 side (a +X direction side) is as a reference side, and an abutting portion 204 side (the −X direction side) opposing the reference side is the non-reference side. The detection unit 27 may be able to detect the image printed on the printing medium PM, a thickness of the printing medium PM, and the like in addition to the two end portions of the printing medium PM. For example, the detection unit 27 includes an optical sensor including a light emitting element and a light receiving element. The light emitting element emits light toward the platen 22, and reflection light thereof is received by the light receiving element. An MPU 31 (see FIG. 4) described later can detect the end portion position of the printing medium PM based on a difference in reflectivity between the printing medium PM and the platen 22 detected by the detection unit 27.

That is, once the carriage 25 scanning in the X direction reaches the platen 22 from the printing medium PM, a value (a voltage value) of the light received by the light receiving element is changed. A threshold is provided to the voltage value, and it is possible to detect the end portion (a reference side end portion 201 and a nonreference side end portion 202) of the printing medium PM based on the carriage position in a case where the value becomes smaller than the threshold. Note that, in the present embodiment, the sensor 27b with high accuracy forming the detection unit 27 is a differential type sensor including one light emitting portion and multiple light receiving portions, which can perform detection with relatively high accuracy. In FIG. 3, the carriage 25 is in a state of being put in contact with the abutting portion 203 in a movement limiting position on a reference side end portion 201 side of the printing medium PM. The abutting portion 203 can be put in contact with the carriage 25, and in a case where the apparatus stops operation or is in a stand-by state, the carriage 25 stops (stands by) in a state of being put in contact with the abutting portion 203 on the reference side end portion 201 side as illustrated in FIG. 3.

In the present embodiment, in a case where the carriage 25 moves in the +X direction, the carriage 25 is put in contact with the abutting portion 203 immediately after the detection unit 27 passes the reference side end portion 201 of the printing medium PM. On the other hand, in a case where the carriage 25 moves in the −X direction from the state in FIG. 3, the carriage 25 is put in contact with the abutting portion 204 immediately after an array of the nozzle 39 closest to the reference side passes the non-reference side end portion 202 of the printing medium PM. In other words, the abutting portions 203 and 204 are provided in the above-described positions. Thus, it is possible to reduce a size of the apparatus in the X direction as small as possible.

FIG. 4 is a block diagram illustrating a control unit 30 in the liquid ejection apparatus 1. The MPU 31 is a processor that controls each operation of the liquid ejection apparatus 1 and controls data processing and the like. The MPU 31 controls overall the liquid ejection apparatus 1 by executing a program stored in a storage device 32. The storage device 32 is formed of a ROM or a RAM, for example. In addition to the program executed by the MPU 31, the storage device 32 stores various data necessary for processing such as data received from a host computer 100.

The MPU 31 controls the printing unit 26 via a driver 34a. The MPU 31 controls a carriage motor 40 via a driver 34b. The MPU 31 controls a conveyance motor 41 and a feeding motor 42 via drivers 34c and 34d. The MPU 31 performs the control operation by obtaining a detection result from a sensor group 35 of various sensors provided to the liquid ejection apparatus 1. The sensor group 35 includes the detection unit 27 and a cover detection sensor (not illustrated). The MPU 31 controls displaying on a display unit of an operation unit 36 and receives information inputted by the operator via the operation unit 36.

The host computer 100 is a personal computer and a mobile terminal (for example, a smart phone, a tablet terminal, and the like) used by the operator, for example. In the host computer 100, a printer driver 101 that establishes communication between the host computer 100 and the liquid ejection apparatus 1 is installed. The liquid ejection apparatus 1 includes an interface unit 33, and the communication between the host computer 100 and the MPU 31 is executed via the interface unit 33. For example, in a case where execution of the printing operation is inputted to the host computer 100 by the operator, the printer driver 101 integrates data of the image as the printing target and setting related to the printing (information such as quality of the printing image) and instructs the liquid ejection apparatus 1 to execute the printing operation.

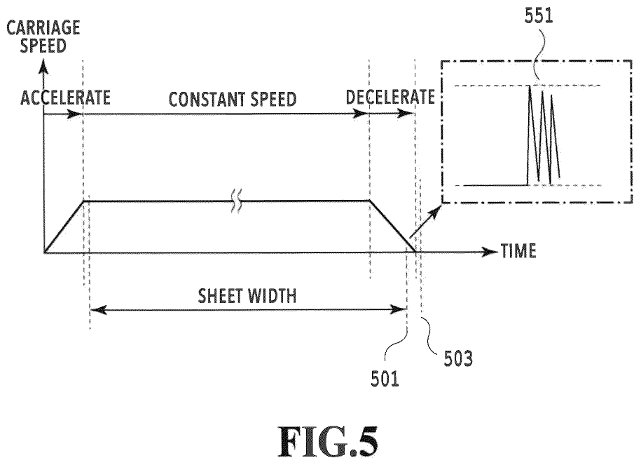

FIG. 5 is a graph illustrating a relationship between an elapsed time from starting the scanning of the carriage and a movement speed of the carriage in the serial type liquid ejection apparatus. The graph in FIG. 5 also illustrates a width of the sheet (the printing medium) and a timing 503 in which the carriage is put in contact with the abutting portion 203 corresponding to the elapsed time. After the carriage accelerates to a predetermined speed, the carriage moves at a constant speed at the predetermined speed, and in general, the carriage stops while decelerating before abutting the abutting portion 203.

Here, a case where the abutting portions 203 and 204 are provided to the positions as described in FIG. 3 for size reduction is considered. For example, in a case where the carriage 25 is moved in the +X direction, in order to stop the carriage without abutting the abutting portion 203, it is necessary to decelerate the carriage 25 before the detection unit 27 detects the reference side end portion 201 of the printing medium. In this case, the carriage is in a decelerating state in a timing 501 in which the detection unit 27 detects the reference side end portion 201 of the printing medium.

However, in a case where the detection unit 27 detects the end portion while the speed of the carriage is within a deceleration range, hunting 551 may occur in an output result of the sensor 27b. As a result, there is a problem that the end portion detection cannot be performed precisely, and a detection accuracy is reduced. That is, in order to perform the end portion detection with high accuracy, it is required for the carriage to move at the constant speed in the timing of performing the end portion detection.

On the other hand, in a case where the carriage 25 is moved in the −X direction, the movement of the carriage 25 continues until the printing unit 26 reaches the non-reference side end portion 202 even after the detection unit 27 detects the nonreference side end portion 202. Therefore, it is possible to decelerate the carriage until the printing unit 26 moves to the non-reference side end portion 202 after the detection unit 27 detects the non-reference side end portion 202, and it is possible to stop the carriage before being put in contact with the abutting portion 204. Therefore, in the present embodiment, the carriage 25 is stopped by putting the carriage 25 in contact with the abutting portion 203 on the reference side, and the carriage 25 decelerates to be stopped without putting the carriage 25 in contact with the abutting portion 204 on the non-reference side.

Hereinafter, a carriage speed control method of the present embodiment is described.

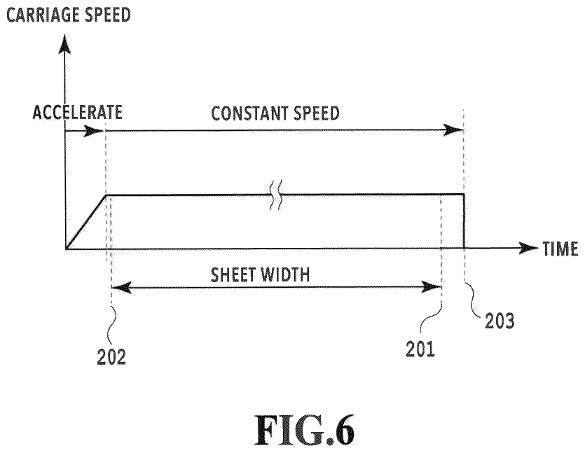

FIG. 6 is a graph illustrating a change in the movement speed of the carriage 25 in a case where the carriage 25 is moved in the +X direction in the present embodiment. Once the carriage 25 accelerates to the predetermined movement speed from the stop state, the carriage 25 moves at the constant speed, the movement at the constant speed is maintained until abutting the abutting portion 203 provided to an end portion in the movement direction of the carriage 25, and the carriage 25 stops by abutting the abutting portion 203. The movement speed of the carriage 25 in a case where the detection unit 27 detects the reference side end portion 201 of the printing medium PM may not be the movement speed in a case of performing the printing. In the present embodiment, the movement speed of the carriage 25 in a case where the sensor 27b with high accuracy detects the reference side end portion 201 of the printing medium PM is a speed slower than the movement speed in a case of performing the printing, which is 8 ips.

In a case of detecting the non-reference side end portion 202 of the printing medium PM by the detection unit 27, the carriage 25 starts the movement from the state of being put in contact with the abutting portion 203 on the reference side end portion 201 side (see FIG. 3) in the direction of the non-reference side end portion 202 (the −X direction) and accelerates to the speed at 8 ips. Once the carriage 25 accelerates to the speed at 8 ips, the carriage 25 moves at the constant speed. In a case where the detection unit 27 passes above the non-reference side end portion 202 in the +Z direction, the detection unit 27 detects the position of the non-reference side end portion 202. Once the position of the non-reference side end portion 202 is detected, the carriage 25 starts deceleration and stops immediately before being put in contact with the abutting portion 204 or after being put in contact lightly. After the detection of the position of the non-reference side end portion 202, since there is a distance to decelerate until reaching the abutting portion 204, the carriage 25 moves while decelerating and then stops substantially concurrently with the contact with the abutting portion 204.

Next, in a case of detecting the reference side end portion 201 of the printing medium PM, the carriage 25 starts the movement in the direction of the reference side end portion 201 (the +X direction) and accelerates to the speed at 8 ips. Once the carriage 25 accelerates to the speed at 8 ips, the carriage 25 moves at the constant speed. In a case where the detection unit 27 passes above the reference side end portion 201 in the +Z direction, the detection unit 27 detects the position of the reference side end portion 201. After the detection unit 27 detects the position of the reference side end portion 201, the carriage 25 stops by abutting the abutting portion 203.

Thus, the detection unit 27 detects the positions of the reference side end portion 201 and the non-reference side end portion 202 of the printing medium PM and obtains the width of the printing medium PM from the detection result.

As described above, in the present embodiment, the detection unit 27 is provided to the side surface of the carriage 25 on the non-reference side, and it is possible to move the carriage 25 at the constant speed in a case where the detection unit 27 detects the positions of the reference side end portion 201 and the non-reference side end portion 202 of the printing medium PM. As a result, it is possible to achieve both the size reduction of the apparatus and end portion detection with high accuracy.

### Modification

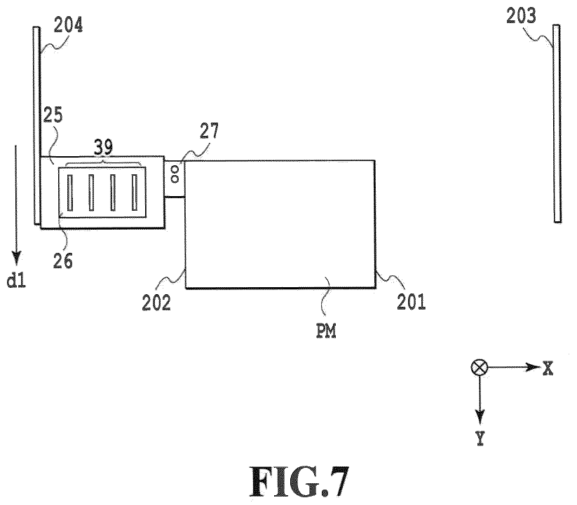

FIG. 7 is a diagram illustrating a modification of the present embodiment. In the modification, the detection unit 27 is provided to a side surface of the carriage 25 on the reference side. In this case, in a case where the reference side end portion 201 of the printing medium PM is detected, the carriage 25 starts the movement from the state of being put in contact with the abutting portion 204 on the non-reference end side in a direction of the reference side (the +X direction) as illustrated in FIG. 7, and once accelerating to the speed at 8 ips, the carriage 25 moves at the constant speed. Then, in a case where the detection unit 27 passes above the reference side end portion 201 in the +Z direction, the detection unit 27 detects the position of the reference side end portion 201. After the position of the reference side end portion 201 is detected, since there is a distance to decelerate until reaching the abutting portion 203, the carriage 25 moves while decelerating and then stops substantially concurrently with the contact with the abutting portion 203.

In a case of detecting the non-reference side end portion 202 of the printing medium PM, the carriage 25 starts the movement in the direction of the non reference side end portion 202 (the −X direction), and once accelerating to the speed at 8 ips, the carriage 25 moves at the constant speed. In a case where the detection unit 27 passes above the non-reference side end portion 202 in the +Z direction, the detection unit 27 detects the position of the non-reference side end portion 202. Immediately after the position of the non-reference side end portion 201 is detected, the carriage 25 moves to the abutting portion 204 without decelerating and stops by abutting the abutting portion 204.

Thus, also in a configuration in which the detection unit 27 is provided to the side surface of the carriage 25 on the reference side, it is possible to provide a technique of detecting the end portion of the printing paper with high accuracy.

### Second Embodiment

Hereinafter, a second embodiment of the present disclosure is described with reference to the drawings. Note that, since a basic configuration of the present embodiment is similar to that of the first embodiment, a characteristic configuration is described hereinafter.

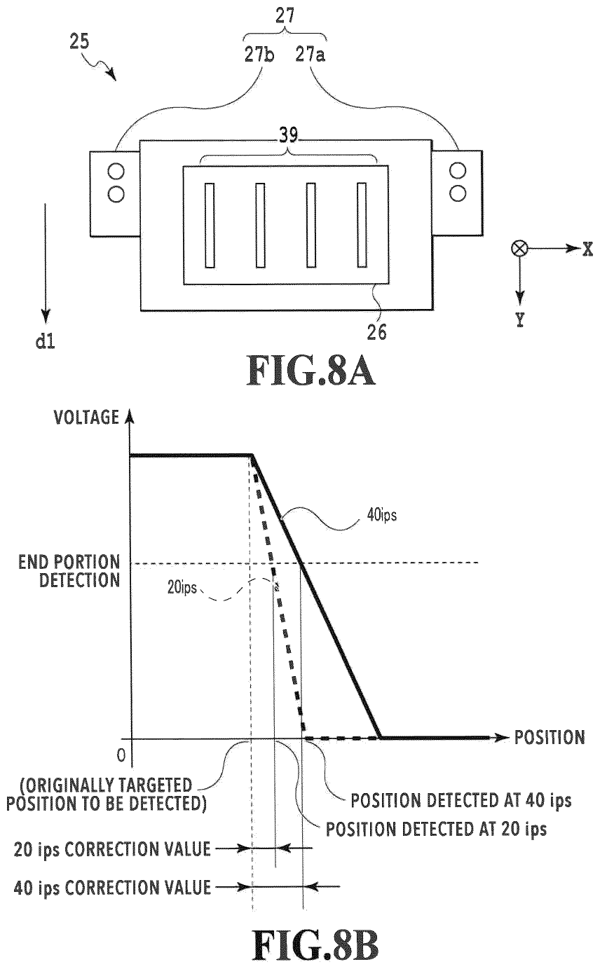

FIG. 8A is a diagram illustrating the carriage 25 in the present embodiment. In the present embodiment, a first sensor 27a with lower accuracy than that of the sensor 27b used in the first embodiment is arranged on the side surface of the carriage 25 on the reference side, and a second sensor 27b with high accuracy that is the same as that in the first embodiment is arranged on the side surface on the non-reference side. The first sensor 27a is a sensor with low accuracy including one light emitting portion and one light receiving portion, and the second sensor 27b is a differential type sensor with high accuracy including one light emitting portion and multiple light receiving portions. The first sensor 27a has a speed dependency, and the higher the carriage speed, the lower the detection accuracy. The sensor 27b with high accuracy has less speed dependency and can perform the detection with high accuracy by detecting the paper end while moving at the constant speed.

FIG. 8B is a graph illustrating a detection result of the first sensor 27a at each carriage speed. Since the first sensor 27a has the speed dependency, the detection accuracy is different depending on the carriage speed. In a case of the first sensor 27a, a detection delay time occurs for the detection of the position of the end portion of the printing medium that is actually desired to be detected, and in a case where the carriage speed is high, a difference from the position that is actually desired to be detected is increased. Accordingly, as illustrated in FIG. 8B, in a case of accurately detecting the end portion position by the first sensor 27a, it is preferable to perform correction according to the carriage speed. Note that, since the second sensor 27b is a differential type, there is almost no difference in the detection accuracy depending on the carriage speed.

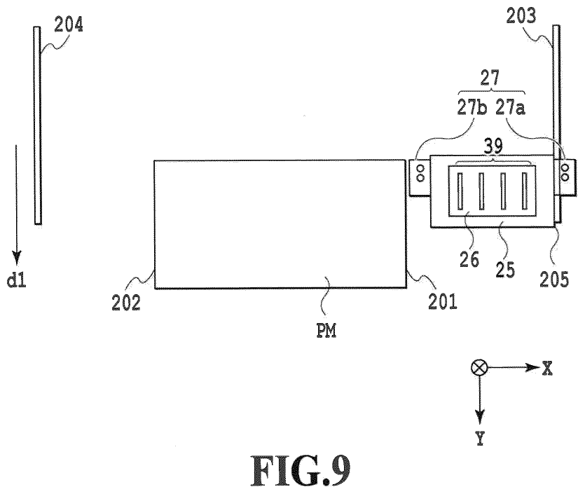

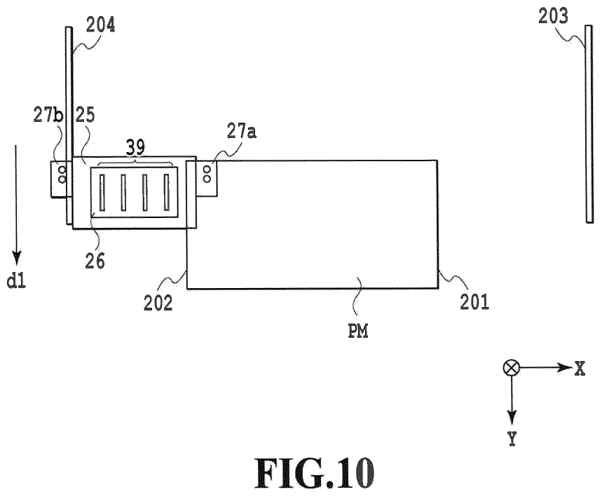

FIGS. 9 and 10 are diagrams illustrating a positional relationship between the carriage 25 and the detection unit 27 in the present embodiment. FIG. 9 illustrates a state in which the carriage 25 is put in contact with the abutting portion 203 on the reference side end portion 201 side of the printing medium PM, and FIG. 10 illustrates a state in which the carriage 25 is put in contact with the abutting portion 204 on the nonreference side end portion 202 side of the printing medium PM.

In the present embodiment, so-called micro margin printing described also in Japanese Patent Laid-Open No. 2017-065131 is performed. Specifically, in order to print the image to be as close as possible to inner sides of the two end portions of the printing medium, the reference side end portion 201 and the non-reference side end portion 202 of the printing medium are detected by using the detection unit 27 in every print scanning, and a starting position and an ending position of the next print scanning are adjusted. In the micro margin printing, the first sensor 27a is used to detect the position of the reference side end portion 201, and the second sensor 27b is used to detect the position of the non-reference side end portion 202. Note that, the second sensor 27b is also used to detect the width of the printing medium before the printing operation. Since the end portion detection by the second sensor 27b is similar to that in the first embodiment, the description is omitted.

The movement speed of the carriage 25 in a case where the end portion detection is performed by the micro margin printing includes a speed during normal printing (in the present embodiment, 40 ips) and a monitor control speed that is limited based on a predetermined condition in a case where, for example, a head temperature is increased during the printing operation (20 ips).

In a case of detecting the reference side end portion 201, the carriage 25 starts the movement from the state of being put in contact with the abutting portion 204 on the non-reference side end portion 202 side (FIG. 10) in the direction of the reference side end portion 201 and accelerates to the speed at 40 ips. Once accelerating to the speed at 40 ips, the carriage 25 moves at the constant speed. In a case where the first sensor 27a passes above the reference side end portion 201 of the printing medium PM in the +Z direction, the first sensor 27a detects the reference side end portion 201. On the other hand, in a case of detecting the non-reference side end portion 202, the carriage 25 starts the movement from the state of being put in contact with the abutting portion 203 on the reference side end portion 201 side (FIG. 9) in the direction of the non-reference side end portion 201 and accelerates to the speed at 40 ips. Once accelerating to the speed at 40 ips, the carriage 25 moves at the constant speed. In a case where the second sensor 27b passes above the non-reference side end portion 202 of the printing medium PM in the +Z direction, the second sensor 27b detects the non-reference side end portion 202. As illustrated in FIG. 10, in a state in which the carriage 25 is put in contact with the abutting portion 204 on the non-reference side end portion 202 side of the printing medium PM, the first sensor 27a does not reach the non-reference side end portion 202 of the printing medium PM. Therefore, the sensor 27a with low accuracy does not detect the non-reference side end portion 202.

As described above, the correction is required since the first sensor 27a has the speed dependency. Therefore, in the present embodiment, the position of the reference side end portion 201 detected by the second sensor 27b and the position of the reference side end portion 201 detected by the first sensor 27a are compared, and a correction value for matching with the position of the second sensor 27b is obtained in advance. In addition, the above-described correction value is obtained in each of cases where the movement speed of the carriage 25 is 40 ips and 20 ips. In a case where the micro margin printing is actually performed, in every print scanning, the position of the reference side end portion 201 obtained by the first sensor 27a is corrected according to the movement speed of the carriage 25.

Thus, it is possible to detect the printing medium end portion position with high accuracy even with a sensor with low accuracy by correcting the detection result of the position of the reference side end portion 201 by the first sensor 27a for the movement speeds at 40 ips and at 20 ips of the carriage 25.

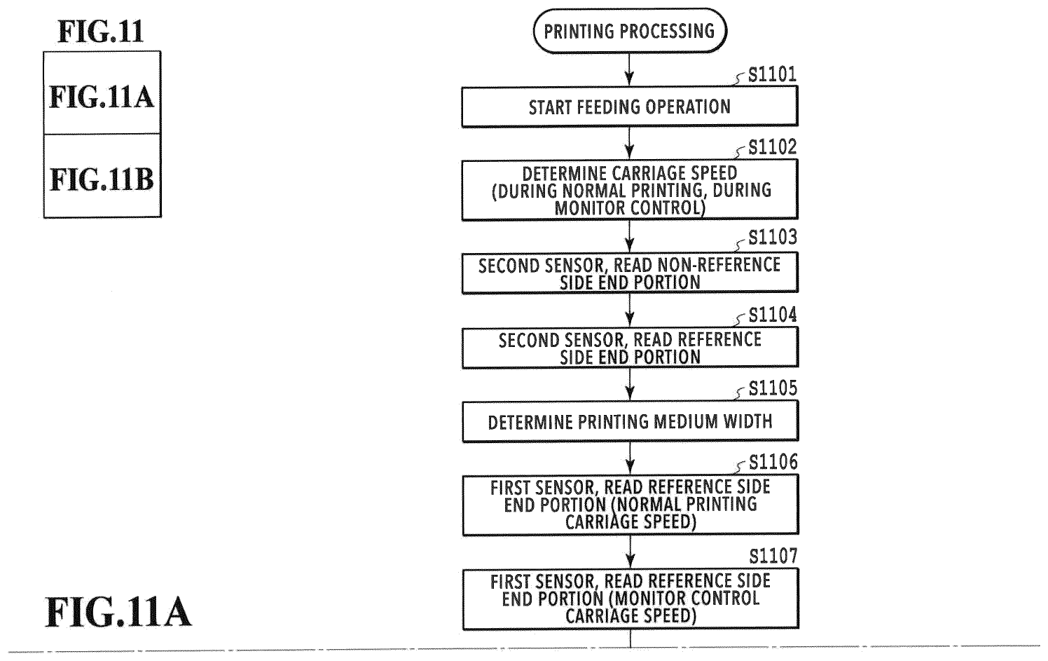

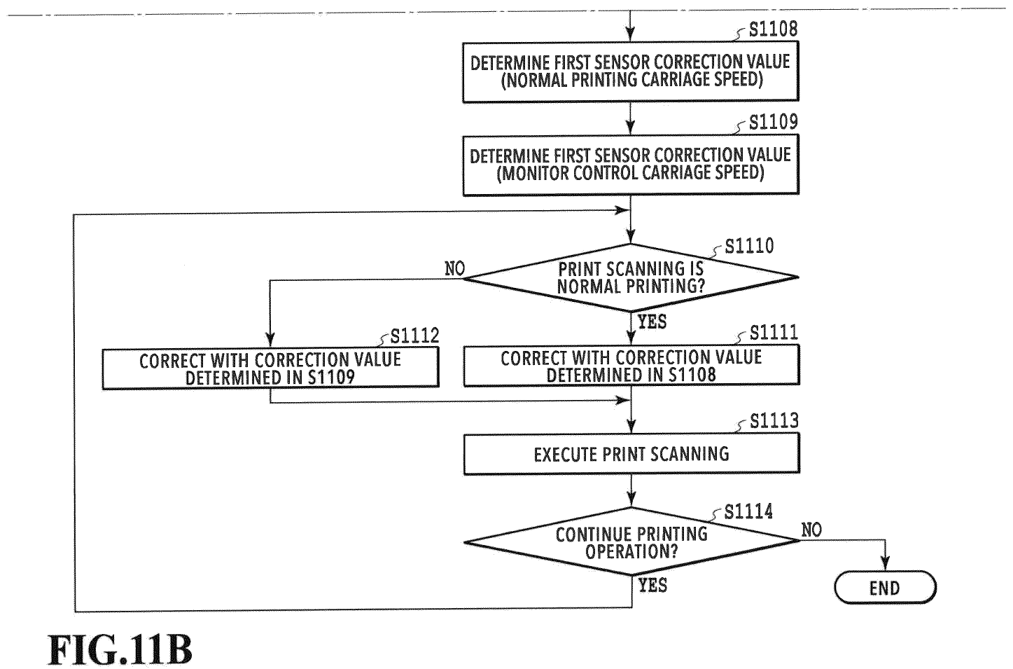

FIG. 11A and FIG. 11B are flowcharts illustrating processing in a case where the micro margin printing is performed in the liquid ejection apparatus 1 in the present embodiment. A series of processing illustrated in FIG. 11A and FIG. 11B are performed with the MPU 31 of the liquid ejection apparatus 1 deploying a program code stored in the ROM of the storage device 32 to the RAM to execute. Alternatively, a part of or all the functions of steps in FIG. 11A and FIG. 11B may be implemented by hardware such as an ASIC or an electronic circuit. Note that, a sign “S” in description of each processing means that it is a step in the flowchart. Hereinafter, the printing processing in the present embodiment is described with reference to the flowchart in FIG. 11A and FIG. 11B.

Once the printing processing of the micro margin is started in response to a printing command from the host computer 100, in S1101, the MPU 31 starts a feeding operation of the printing medium PM. In S1102, the MPU 31 determines the carriage speed used in the printing (40 ips) and the carriage speed reduced in a case where, for example, the head temperature is increased during the printing operation (the carriage speed in a case where monitor control is performed=20 ips). In S1103, the MPU 31 scans the carriage 25 in the −X direction at the carriage speed used in the printing to allow the second sensor 27b to pass above the non-reference side end portion 202 to detect the position of the non-reference side end portion 202 and obtain the detection result. After the second sensor 27b passes the non-reference side end portion 202, the carriage 25 decelerates and then stops substantially concurrently with the contact with the abutting portion 203.

In S1104, the MPU 31 scans the carriage 25 in the +X direction at the carriage speed used in the printing and allows the second sensor 27b to pass above the reference side end portion 201 to detect the position of the reference end 202 and obtain the detection result. In this case, the carriage 25 stops by abutting the abutting portion 204 without decelerating.

In S1105, the MPU 31 determines the width of the printing medium PM (a paper width) based on the positions of the reference side end portion 201 detected in S1104 and the non-reference side end portion 202 detected in S1103.

Next, in S1106, the MPU 31 moves the carriage 25 in the +X direction at the carriage speed used during the normal printing (in the present embodiment, 40 ips) to detect the position of the reference side end portion 201 by using the first sensor 27a and obtain the detection result.

Additionally, in S1107, the MPU 31 moves the carriage 25 in the +X direction at the carriage speed (20 ips) to detect the position of the reference side end portion 201 by using the first sensor 27a and obtain the detection result.

In S1108, the MPU 31 determines the correction value of the first sensor 27a at the carriage speed during the normal printing from the detection result of the second sensor 27b (S1104) and the detection result of the first sensor 27a at the carriage speed during the normal printing (S1106) in the reference side end portion 201. In S1109, the MPU 31 determines the correction value of the first sensor 27a at the carriage speed during the monitor control from the detection result of the second sensor 27b (S1104) and the detection result of the first sensor 27a at the carriage speed during the monitor control (S1107) in the reference side end portion 201.

In S1110, the MPU 31 determines whether the next print scanning is the print scanning at the normal speed. If it is the print scanning at the normal speed, the processing proceeds to S1111, and if it is not the printing at the normal speed (that is, it is the monitor control carriage speed), the processing proceeds to S1112. If it is the print scanning at the normal speed, in S1111, the MPU 31 sets the correction value determined in S1108. If it is not the print scanning at the normal speed, that is, if it is the monitor control carriage speed, the correction value determined in S1109 is set.

In S1113, the MPU 31 executes the print scanning. In this case, the positions of the reference side end portion 201 and the non-reference side end portion 202 of the printing medium are obtained while causing the printing unit 26 to perform the ejection operation according to the printing data. As for the position of the reference side end portion 201, the detection result of the first sensor 27a is corrected by using the correction value set in S1111 or S1112. The thus-obtained positions of the reference side end portion 201 and the non-reference side end portion 202 are used to control the printing position of the image in the next print scanning. Once the print scanning is completed one time, in S1114, the MPU 31 determines whether the next print scanning is necessary (that is, whether the image data that should be printed is still left). In a case where the next print scanning is necessary, the processing proceeds to S1110, and the processing is repeated. If the next print scanning is unnecessary, the present printing processing ends. On the other hand, in S1114, if it is determined that the next print scanning is unnecessary (that is, the printing operation is completed), the present processing ends.

In the present embodiment, as described above, a configuration in which the first sensor 27a with low accuracy is provided to the side surface of the carriage 25 on the reference side and the second sensor 27b with high accuracy is provided to the side surface on the non-reference side is applied. In addition, the second sensor 27b detects the reference side end portion 201 while moving the carriage at the constant speed, and based on the thus-obtained position of the reference side end portion 201, the position of the reference side end portion 201 detected by the first sensor 27a is corrected. Based on the above-described correction, a region in the scanning direction in which the liquid ejection head is allowed to eject the liquid is changed. Thus, it is possible to perform the micro margin printing with high accuracy while detecting the end portion of the printing medium with high accuracy.

### Third Embodiment

Hereinafter, a third embodiment of the present disclosure is described with reference to the drawings. Note that, since a basic configuration of the present embodiment is similar to that of the first embodiment, a characteristic configuration is described hereinafter.

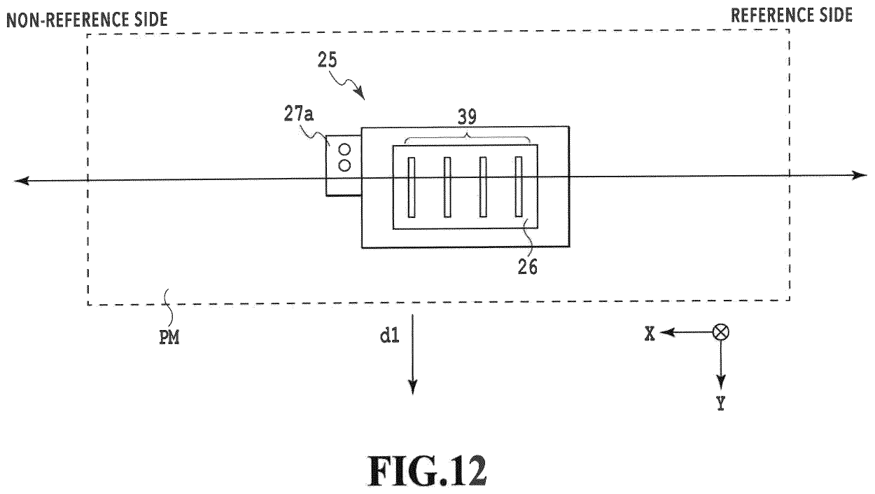

FIG. 12 is a diagram illustrating the carriage 25 and the detection unit 27 in the present embodiment. In the present embodiment, a sensor 27a similar to the first sensor 27a used in the second embodiment is provided to the non-reference side of the carriage 25 as the detection unit 27. The sensor 27a has the speed dependency, and the higher the speed during the detection, the lower the detection accuracy. In the present embodiment, correction is performed by utilizing the characteristic of the sensor 27a as described above. Specifically, the detection performed by the sensor 27a at high speed is corrected by using the detection result of the sensor 27a obtained at a considerably low speed. Hereinafter, the method is described.

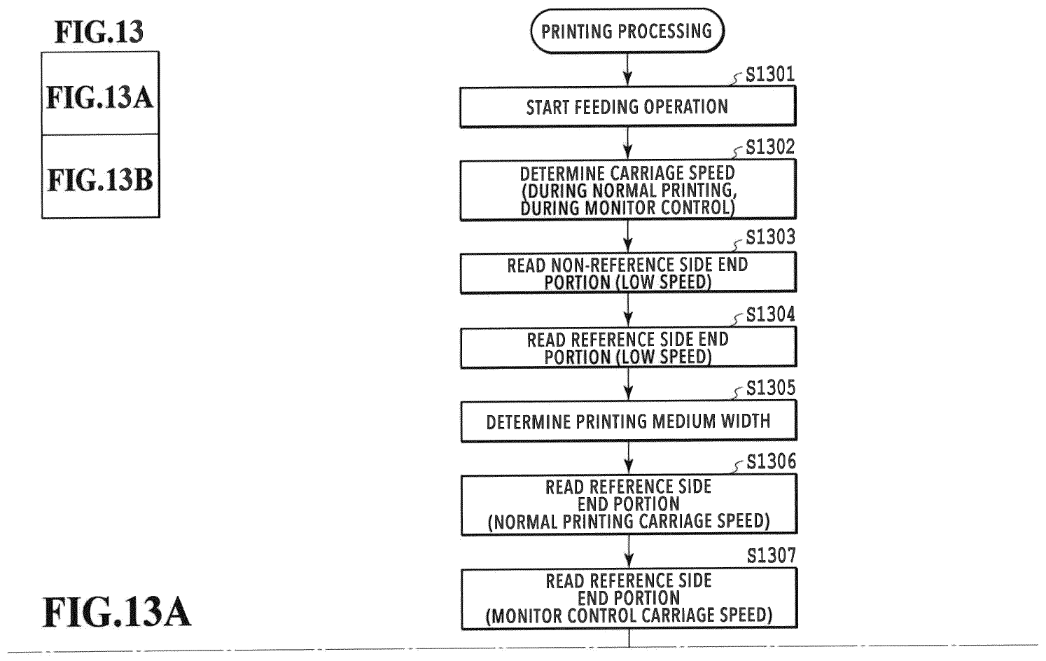

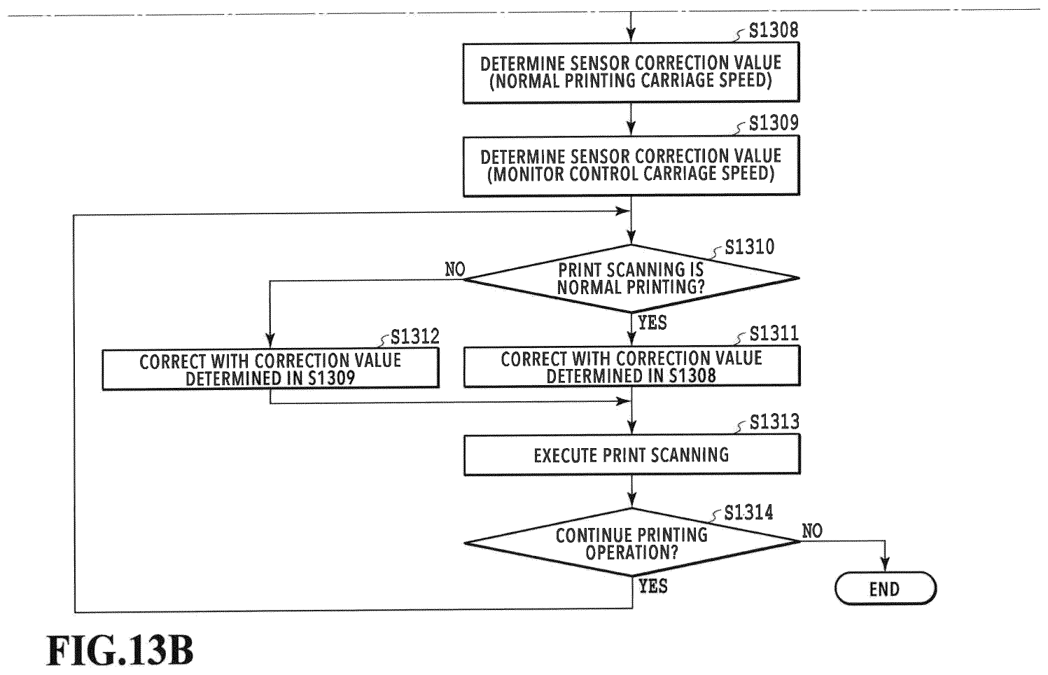

FIG. 13A and FIG. 13B are flowcharts illustrating the printing processing in the liquid ejection apparatus 1 of the present embodiment. A series of processing illustrated in FIG. 13A and FIG. 13B are performed with the MPU 31 of the liquid ejection apparatus 1 deploying a program code stored in the ROM of the storage device 32 to the RAM to execute. Alternatively, a part of or all the functions of steps in FIG. 13A and FIG. 13B may be implemented by hardware such as an ASIC or an electronic circuit. Note that, a sign “S” in description of each processing means that it is a step in the flowchart. Hereinafter, the printing processing in the present embodiment is described with reference to the flowchart in FIG. 13A and FIG. 13B.

Once the printing processing of the micro margin is started in response to the printing command from the host computer 100, in S1301, the MPU 31 starts the feeding operation of the printing medium PM. In S1302, the MPU 31 determines the carriage speed used in the printing (40 ips) and the carriage speed reduced in a case where, for example, the head temperature during the printing operation is increased (the carriage speed in a case where the monitor control is performed=20 ips).

In S1303, the MPU 31 scans the carriage 25 in the −X direction at a speed slower than the monitor control (in the present embodiment, 5 ips) and allows the sensor 27a to pass above the non-reference side end portion 202 to detect the position of the non-reference side end portion 202 and obtain the detection result. The speed in this case is a speed during the micro margin printing that allows the detection delay as described in FIG. 8B to be an error that is not a problem for the image. In S1304, the MPU 31 scans the carriage 25 in the +X direction at a speed slower than the monitor control (in the present embodiment, 5 ips) and allows the sensor 27a to pass above the reference side end portion 201 to detect the position of the reference side end portion 201 and obtain the detection result. In the detection of the reference side end portion 201, the carriage 25 stops by abutting the abutting portion 203. In S1305, the MPU 31 determines the width of the printing medium PM (the paper width) based on the positions of the reference side end portion 201 and the non-reference side end portion 202 detected at the low speed (5 ips).

In S1306, the MPU 31 moves the carriage 25 in the +X direction at the carriage speed used during the normal printing (in the present embodiment, 40 ips) to detect the position of the reference side end portion 201 by using the sensor 27a and obtain the detection result. In this case, the carriage 25 stops by abutting the abutting portion 203.

Thereafter, in S1307, the MPU 31 moves the carriage 25 in the +X direction at the carriage speed (20 ips) to detect the position of the reference side end portion 201 by using the sensor 27a and obtain the detection result. The carriage 25 stops by abutting the abutting portion 203.

In S1308, the MPU 31 determines the correction value of the sensor 27a at the carriage speed during the normal printing from the detection result obtained at the slow carriage speed (S1304) and the detection result obtained at the carriage speed during the normal printing (S1306) in the reference side end portion 201. In S1309, the MPU 31 determines the correction value of the sensor 27a at the carriage speed during the monitor control from the detection result obtained at the slow carriage speed (S1304) and the detection result at the carriage speed during the monitor control (S1307) in the reference side end portion 201.

In S1310, the MPU 31 determines whether the next print scanning is the print scanning at the normal speed. If it is the print scanning at the normal speed, the processing proceeds to S1311, and if it is not the printing at the normal speed (that is, it is the monitor control carriage speed), the processing proceeds to S1312. If it is the print scanning at the normal speed, in S1311, the MPU 31 sets the correction value determined in S1308. If it is not the print scanning at the normal speed, that is, if it is the monitor control carriage speed, in S1312, the correction value determined in S1309 is set. [0070] In S1313, the MPU 31 executes the print scanning. In this case, the positions of the reference side end portion 201 and the non-reference side end portion 202 of the printing medium are obtained while causing the printing unit 26 to perform the ejection operation according to the printing data. As for the positions of the end portions, the detection result of the sensor 27a is corrected by using the correction value set in S1311 or S1312. The thus-obtained positions of the reference side end portion 201 and the non-reference side end portion 202 are used to control the printing position of the image in a case of the next print scanning. Once the print scanning is completed one time, in S1314, the MPU 31 determines whether the next print scanning is necessary (that is, whether the image data that should be printed is still left). In a case where the next print scanning is necessary, the processing proceeds to S1310, and the processing is repeated. If the next print scanning is unnecessary, the present printing processing ends.

In the present embodiment, as described above, a configuration in which the detection unit 27 including the sensor 27a having the high speed dependency is provided to the side surface of the carriage 25 on the non-reference side is applied. In addition, the detection unit 27 detects the end portion of the printing medium on the reference side while moving the carriage at a low speed that can ignore the speed dependency, and based on the thus-obtained end portion position of the printing medium on the reference side, the end portion position of the printing medium at the normal speed is corrected. Thus, it is possible to perform the micro margin printing with high accuracy while detecting the end portion of the printing paper.

According to the present disclosure, it is possible to provide a technique of detecting an end portion of printing paper with high accuracy.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-164359, filed Sep. 20, 2024, which is hereby incorporated by reference herein in its entirety.

What is claimed is:

1. A liquid ejection apparatus, comprising:
a conveyance unit that conveys a sheet in a conveyance direction;
a carriage in which a liquid ejection head is loaded and that can reciprocally move in a scanning direction crossing the conveyance direction;
a first abutting portion that can be put in contact with the carriage in a movement limiting position of the carriage on one end side in the scanning direction;
a second abutting portion that can be put in contact with the carriage in a movement limiting position of the carriage on the other end side opposing the one side in the scanning direction;
a first detection unit that is provided to an end portion of the carriage on the other end side and detects an end portion position of a printing medium while moving with the carriage; and
a control unit that controls movement of the carriage and the first detection unit, wherein
in a case where the first detection unit detects an end portion position of the printing medium on the one end side, the control unit moves the carriage at a constant speed until the carriage abuts the first abutting portion.

2. The liquid ejection apparatus according to claim 1, wherein
after the first detection unit detects an end portion position of the printing medium on the other end side, the control unit decelerates a movement speed of the carriage before the carriage abuts the second abutting portion.

3. The liquid ejection apparatus according to claim 2, wherein
after the first detection unit detects the end portion position of the printing medium on the other end side, the control unit stops the carriage before the carriage abuts the second abutting portion.

4. The liquid ejection apparatus according to claim 1, further comprising:
a second detection unit that is provided to an end portion of the carriage on the one end side and detects the end portion position of the printing medium while moving.

5. The liquid ejection apparatus according to claim 4, wherein
the second detection unit has a speed dependency in a detection result higher than that of the first detection unit, and
the liquid ejection apparatus further includes a correction unit that corrects the detection result of the second detection unit according to a detection result of the first detection unit.

6. The liquid ejection apparatus according to claim 5, wherein
based on the end portion position on the one end side that is detected by the first detection unit while moving the carriage from the other end side to the one end side, the correction unit corrects the end portion position on the one end side that is detected by the second detection unit while moving the carriage from the other end side to the one end side.

7. The liquid ejection apparatus according to claim 6, wherein
the correction unit corrects the detection result of the second detection unit with a first correction value in a case where a movement speed of the carriage during detection by the second detection unit is a first movement speed, and the correction unit corrects the detection result of the second detection unit with a second correction value different from the first correction value in a case where the movement speed of the carriage during detection by the second detection unit is a second movement speed different from the first movement speed.

8. The liquid ejection apparatus according to claim 1, further comprising:
a correction unit that corrects a detection result detected by the first detection unit in a case where a movement speed of the carriage is a second movement speed faster than a first movement speed based on a detection result detected by the first detection unit in a case where the movement speed of the carriage is the first movement speed.

9. The liquid ejection apparatus according to claim 8, wherein
the first movement speed is a movement speed of the carriage during a printing operation, and
the second movement speed is a movement speed of the carriage during the printing operation that is limited based on a predetermined condition.

10. The liquid ejection apparatus according to claim 4, wherein
the first detection unit and the second detection unit are optical sensors.

11. The liquid ejection apparatus according to claim 10, wherein
the first detection unit is a differential type sensor.

12. The liquid ejection apparatus according to claim 1, wherein
the control unit prints an image on the printing medium by causing the liquid ejection head to eject a liquid while moving the carriage in the scanning direction, and
a region in the scanning direction in which the liquid ejection head is caused to eject the liquid is changed based on the end portion position of the printing medium that is obtained by the first detection unit.

13. An end portion detection method, comprising: conveying a printing medium in a conveyance direction;
reciprocally moving a carriage between a movement limiting position on one end side and a movement limiting position on a other end side in a scanning direction crossing the conveyance direction; and
detecting an end portion position of the printing medium by a first detection unit provided to an end portion of the carriage on the other end side, wherein
in a case where an end portion position of the printing medium on the one end side is detected in the detecting, the carriage is moved at a constant speed until the carriage abuts an abutting portion in the movement limiting position on the one end side.

14. The end portion detection method according to claim 13, wherein
after the first detection unit detects an end portion position of the printing medium on the other end side, a movement speed of the carriage decelerates before the carriage abuts an abutting portion in the movement limiting position on the other end side.

15. The end portion detection method according to claim 14, wherein
after the first detection unit detects the end portion position of the printing medium on the other end side, the carriage is stopped before the carriage abuts the abutting portion in the movement limiting position on the other end side.

16. The end portion detection method according to claim 13, further comprising:
detecting the end portion position of the printing medium by a second detection unit provided to an end portion of the carriage on the one end side while moving.

17. The end portion detection method according to claim 16, further comprising:
correcting a detection result of the second detection unit that has a speed dependency in the detection result higher than that of the first detection unit based on a detection result of the first detection unit.

18. The end portion detection method according to claim 17, wherein
in the correcting, based on the end portion position on the one end side that is detected by the first detection unit while moving the carriage from the other end side to the one end side, the end portion position on the one end side that is detected by the second detection unit while moving the carriage from the other end side to the one end side is corrected.

19. The end portion detection method according to claim 18, wherein
in the correcting, the detection result of the second detection unit is corrected with a first correction value in a case where a movement speed of the carriage during the detection by the second detection unit is a first movement speed, and the detection result of the second detection unit is corrected with a second correction value different from the first correction value in a case where the movement speed of the carriage during the detection by the second detection unit is a second movement speed different from the first movement speed.

20. The end portion detection method according to claim 13, further comprising:
correcting a detection result detected by the first detection unit in a case where a movement speed of the carriage is a second movement speed faster than a first movement speed based on a detection result detected by the first detection unit in a case where the movement speed of the carriage is the first movement speed.
